(19) United States
(12) Patent Application Publication
(10) Pub. No.: US 2006/0256222 A1
(43) Pub. Date: Nov. 16, 2006

(54) CIS Package and Method Thereof

(76) Inventor: Yu-Pin Tsai, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 11/164,891

(22) Filed: Dec. 9, 2005

(30) Foreign Application Priority Data
May 11, 2005 (TW) 094115188

(51) Int. Cl. H04N 5/335

(52) U.S. Cl. 348/308

(57) ABSTRACT

A method of fabricating a CMOS image sensor (CIS) package includes: providing a transparent substrate, in which the transparent substrate includes a cavity; disposing an image sensor chip in the cavity and forming a plurality of bumps between the image sensor chip and the transparent substrate, in which the image sensor chip includes a light sensitive area; forming a barrier wall between the transparent substrate and the image sensor chip, in which the barrier wall further forms a circular pattern around the light sensitive area of the image sensor chip; and forming an underfill layer between the transparent substrate and the image sensor chip for forming a package structure.

### BACKGROUND OF THE INVENTION

1. Field of the Invention

The present invention relates to a method of fabricating image sensors, and more particularly, to a method of fabricating CMOS image sensor packages.

2. Description of the Prior Art

Image sensor components such as charge coupled devices or CMOS image sensors have been widely applied to electronic products for converting light into electrical signals. The applications of image sensor components include: monitors, cell phones, transcription machines, scanners, digital cameras, and so on. As the size of image sensing components continues to shrink, the back end packaging processes for the image sensing components becomes increasingly critical. It is known that the prior art image sensor packaging processes such as Plastic Leaded Chip Carrier (PLCC) or Ceramic Leaded Chip Carrier (CLCC) provide poor performance and low yield.

Please refer to FIG. 1. FIG. 1 illustrates a prior art package structure of an image sensing component. As shown in FIG. 1, the image sensing component 1 is attached to a plastic or ceramic carrier substrate 2. Typically, the image sensing component 1 is placed in a recessed area of the carrier substrate 2 and is sealed by a glass lid 3. The inner circuitry of the image sensing component 1 is connected to outer circuitry via bonding wires 4.

The above-described conventional package structure of an image sensing component exhibits several drawbacks. For example, the packaging procedure is complicated, leading to long manufacture cycling time. Additionally, contaminants such as dusts or other particles are easily introduced during packaging, thereby reducing product yields. Furthermore, the package size according to the prior art is too large.

### SUMMARY OF THE INVENTION

It is therefore an objective of the present invention to provide a method of fabricating CMOS image sensor packages to effectively reduce the cost and fabrication time offered by the conventional method.

According to the present invention, a method of fabricating a CMOS image sensor (CIS) package includes: providing a transparent substrate, in which the transparent substrate comprises a cavity; disposing an image sensor chip in the cavity and forming a plurality of bumps between the image sensor chip and the transparent substrate, wherein the image sensor chip comprises a light sensitive area; forming a barrier wall between the transparent substrate and the image sensor chip, wherein the barrier wall further forms a circular pattern around the light sensitive area of the image sensor chip; and forming an underfill layer between the transparent substrate and the image sensor chip for forming a package structure.

By utilizing a compressed transparent substrate to contain an image sensor chip, utilizing a plurality of bumps to conduct other external devices, and utilizing an insulating barrier gel to isolate the light sensitive area of the image sensor chip from the outside environment, the present invention is able to effectively prevent contamination by dusts and other particles during the packaging process, reduce overall cost, and simplify the process of fabrication.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a prior art package structure of an image sensing component.

FIG. 2 through FIG. 6 are perspective diagram showing the means of fabricating a CMOS image sensor (CIS) package according to the present invention.

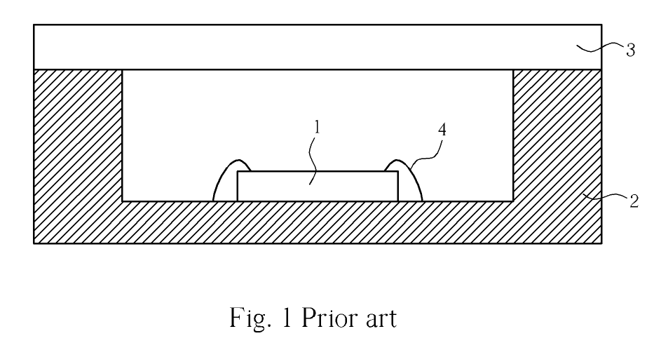

### DETAILED DESCRIPTION

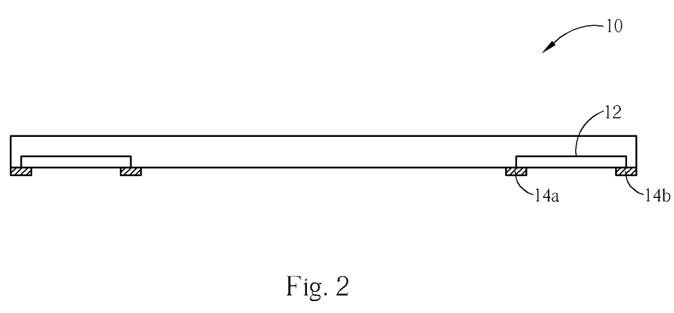

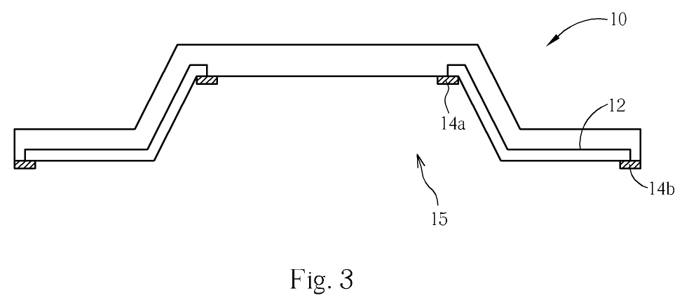

Please refer to FIG. 2 through FIG. 6. FIG. 2 through FIG. 6 are perspective diagram showing the means of fabricating a CMOS image sensor (CIS) package according to the present invention. As shown in FIG. 2, a transparent substrate 10 having at least an inner circuit layer 12 and a plurality of external pads 14a and 14b is provided, in which the external pads 14a and 14b are interconnected by utilizing the inner circuit layer 12. Preferably, the transparent substrate 10 is composed of a thermosetting material, such as a thermosetting plastic or a thermosetting glass. Next, an injection molding process or a compression process is performed to form a disc-shaped cavity 15 from the transparent substrate 10. After the formation of the disc-shaped cavity 15, a heating process is performed to cure the transparent substrate 10, as shown in FIG. 3. Preferably, the external pads 14a and 14b can be separately formed inside or outside the cavity 15, such that the external pad 14a is disposed on the interior surface relative to the cavity 15 whereas the external pad 14b is disposed on the surface of the transparent substrate 10 external to the cavity 15.

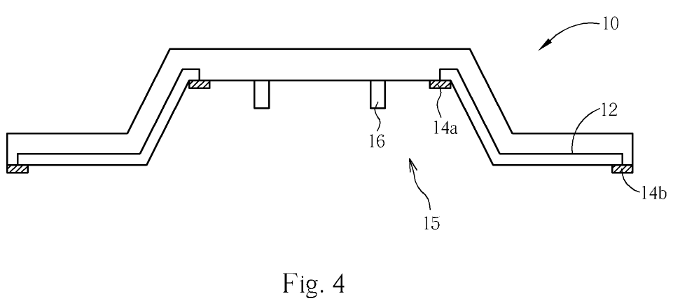

As shown in FIG. 4, a barrier wall 16 is formed in the cavity 15 of the transparent substrate 10 and surrounding the surface of the transparent substrate 10. According to the preferred embodiment of the present invention, the barrier wall 16 is composed of a gel material, such as a B-stage resin or a UV curing adhesive, in which the barrier wall 16 is fabricated by utilizing a printing process or a dispensing process.

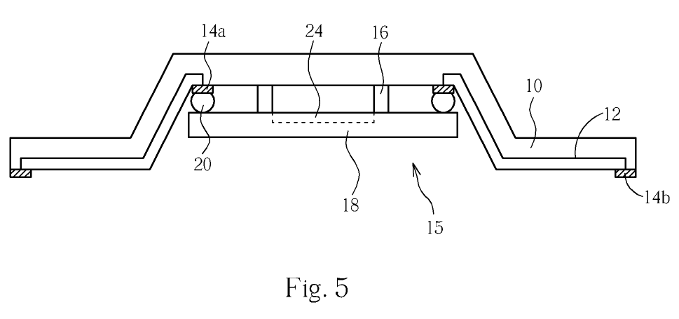

As shown in FIG. 5, an image sensor chip 18 is provided, in which the image sensor chip 18 includes a light sensitive area 24 and a plurality of bonding pads (not shown) disposed between the image sensor chip 18 and the transparent substrate 10. Next, the image sensor chip 18 is disposed in the cavity 15 and fixed on the transparent substrate 10 by utilizing the barrier wall 16. Preferably, each bonding pad of the image sensor chip 18 is located corresponding to each of the external pads 14a, in which a bump 20 is formed on each bonding pad for connecting the bonding pad and the corresponding external pad 14a. By utilizing the bumps 20 formed between the image sensor chip 18 and the transparent substrate 10, the present invention is able to electrically connect the bonding pads on the image sensor chip 18 to the transparent substrate 10, in which the bumps 20 are composed of copper, gold, copper-nickel alloy, copper-silver alloy, copper-gold alloy, solder, or tin-silver. Alternatively, the barrier wall 16 can be first formed on the image sensor chip 18 and utilized to surround the light sensitive area 24 of the image sensor chip 18. Subsequently, the image sensor chip 18 is fixed in the cavity 15 by mounting the image chip 18 containing the barrier wall 16 to the surface of the transparent substrate 10.

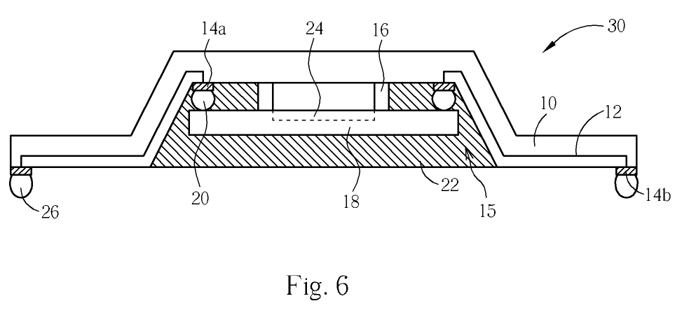

As shown in FIG. 6, an underfill layer 22 is formed between the transparent substrate 10 and the image sensor chip 18 and a package structure 30 is formed by utilizing the underfill layer 22 to protect the image sensor chip 18 and maintain the overall shape of the package structure. After the formation of the underfill layer 22, a plurality of solder balls 26 is formed on the external pads 14b of the transparent substrate 10, in which the image sensor chip 18 can be electrically connected to an external device (not shown) by utilizing the bumps 20, the inner circuit layer 12, and the solder balls 26.

As shown in FIG. 6, a CMOS image sensor (CIS) package structure 30 is disclosed, in which the CIS package structure 30 includes a transparent substrate 10, an image sensor chip 18, a barrier wall 16, a plurality of bumps 20, and an underfill layer 22. Preferably, the transparent substrate 10 includes a cavity 15, at least an inner circuit layer 12, and a plurality of external pads 14a and 14b disposed on the surface of the transparent substrate 10. As described previously, the transparent substrate 10 is composed of a thermosetting material, such as a thermosetting plastic or a thermosetting glass.

Additionally, the image sensor chip 18 is disposed in the cavity 15, in which the image sensor chip 18 further includes a light sensitive area 24. In order to form an insulating and transparent area on the image sensor chip 18, the barrier wall 16 is formed around the light sensitive area 24 of the image sensor chip 18 and between the image sensor chip 18 and the transparent substrate 10. Preferably, the barrier wall 16 is composed of a B-stage resin or a UV curing adhesive, and a closed space is formed by the barrier wall 16, the image sensor chip 18, and the transparent substrate 10. When the barrier wall 16 is utilized to bond the image sensor chip 18 on the transparent substrate 10, a plurality of bumps 20 is disposed between the image sensor chip 18 and the transparent substrate 10, in which the bumps 20 are composed of copper, gold, copper-nickel alloy, copper-silver alloy, copper-gold alloy, solder, or tin-silver and utilized to electrically connect the image sensor chip 18 and the inner circuit layer 12. Preferably, the underfill layer 22 formed between the transparent substrate 10 and the image sensor chip 18 functions to protect the image sensor chip 18 and shape the entire structure into a package structure 30. Additionally, the shape and location of the underfill layer 22 can be manipulated by utilizing other molding equipments, such as forming the underfill layer 22 on the outer rim of the upper surface of the transparent substrate 10 to allow the upper surface of the underfill layer 22 having an equal height as the center portion (hence the cavity 15 portion) of the transparent substrate 10, or filling the entire bottom part of the package structure 30 with the underfill layer 22 while only exposing the solder balls 26 to produce a package structure 30 with irregular shape. As a result, by adjusting the location and shape of the underfill layer 22, a package structure with various shapes can thereby be produced.

In contrast to the conventional image sensor package structure, the present invention first compresses a transparent substrate having an inner circuit layer to form a cavity, and disposes a barrier gel on the surface of the transparent substrate to fix the image sensor chip in the cavity and around the image sensor chip to form an insulating light sensitive area. Subsequently, a plurality of bumps is formed between the image sensor chip and the transparent substrate to electrically connect the inner circuit layer of the transparent substrate and the image sensor chip, and an underfill layer is formed to maintain an overall shape and produce a final package structure.

By utilizing a compressed transparent substrate to contain an image sensor chip, utilizing a plurality of bumps to conduct other external devices, and utilizing an insulating barrier gel to isolate the light sensitive area of the image sensor chip from the outside environment, the present invention is able to effectively prevent the contamination of dusts and particles from offering any interference during packaging process, thereby reducing the overall cost, and simplify the fabrication process.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A CMOS image sensor package comprising:
a transparent substrate comprising a cavity and at least an inner circuit layer;
an image sensor chip disposed in the cavity, wherein the image sensor chip comprises a light sensitive area;
a barrier wall disposed around the light sensitive area of the image sensor chip and between the image sensor chip and the transparent substrate;
a plurality of bumps disposed between the image sensor chip and the transparent substrate and electrically connected to the image sensor chip and the inner circuit layer; and
an underfill layer formed between the transparent substrate and the image sensor chip.

2. The CMOS image sensor package of claim 1, wherein a closed space is enclosed by the barrier wall, the image sensor chip, and the transparent substrate.

3. The CMOS image sensor package of claim 1, wherein the transparent substrate is a thermosetting substrate.

4. The CMOS image sensor package of claim 3, wherein the thermosetting substrate comprises a thermosetting plastic or a thermosetting glass.

5. The CMOS image sensor package of claim 1, wherein the barrier wall comprises a gel material.

6. The CMOS image sensor package of claim 5, wherein the gel material comprises a B-stage resin or an UV curing adhesive.

7. The CMOS image sensor package of claim 1, wherein the surface of the transparent substrate further comprises a plurality of external pads.

8. The CMOS image sensor package of claim 7, wherein the external pads comprise a plurality of solder balls formed thereon.

9. The CMOS image sensor package of claim 1, wherein the bumps comprise copper, gold, copper-nickel alloy, copper-silver alloy, copper-gold alloy, solder, or tin-silver.
